(19) United States
(12) Patent Application Publication
(10) Pub. No.: US 2007/0142102 A1
(43) Pub. Date: Jun. 21, 2007

(54) Mobile communication terminal having multiple keypads and main body thereof

(75) Inventor: Hyoung Sik Kim, Yongin-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/585,624

(22) Filed: Oct. 24, 2006

(30) Foreign Application Priority Data
Dec. 19, 2005 (KR) 2005-0125488

(51) Int. Cl. H04M 1/00

(52) U.S. Cl. 455/575.4

(57) ABSTRACT

Disclosed is are a mobile communication terminal having multiple keypads, which includes a primary keypad installed on the front side, and secondary keypads installed on the backside. In particular, the secondary keypads are installed at two opposite upper end edges of the backside of the main body so that the secondary keypads can be manipulated easily with the index fingers. As a result, the keypads installed at the two sides of the main body can facilitate a convenient operation of the mobile communication terminal.

### PRIORITY

This application claims priority to an application entitled “MOBILE COMMUNICATING TERMINAL HAVING MULTIPLE KEYPADS AND MAIN BODY THEREOF” filed with the Korea Intellectual Property Office on Dec. 19, 2005 and assigned Serial No. 2005-0125488, the contents of which are incorporated herein by reference.

### BACKGROUND OF THE INVENTION

1. Field of the Invention

The present invention relates generally to a mobile communication terminal and, more particularly, to a mobile communication terminal having multiple keypads, that can be easily operated through the multiple keypads arranged on two sides of the mobile communication terminal, and on a main body of the mobile communication terminal.

2. Description of the Related Art

Generally, communication terminals may be divided into wired communication terminals and wireless communication terminals. Office and home telephones are examples of wired communication terminals. Personal Communication Services (PCS) phones, cellular phones and Personal Digital Assistants (PDAs) are examples of wireless communication terminals. Because a wireless communication terminal typically provides portability and mobility to the user, it is also referred to as a mobile communication terminal or a portable terminal.

With advances in mobile communication technologies, a mobile communication terminal can transmit not only simple voice information but also text information, image information, Moving Picture Experts Group (MPEG) audio layer 3 (MP3) files, and games to the user, who can enjoy the transmitted contents through the display screen of the mobile communication terminal. Such a mobile communication terminal may be a bar type, cover-equipped flip type, folder type, or sliding type.

A conventional mobile communication terminal includes a display screen, a keypad installed below the display screen, and a navigation pad installed between the display screen and keypad. The keypad is used to input characters and numerals, and the navigation pad is used to perform specialized operations.

When the user tries to send character information such as short messages, the keypad is used mainly to input characters, and the navigation pad is used mainly to correct errors and move a cursor during a character input operation.

However, because there is a predetermined separation distance between the keypad and navigation pad, it is often cumbersome for the user to move from the keypad to the navigation pad and manipulate the navigation pad while inputting characters through the keypad. That is, it is cumbersome for the user to move at least one thumb from the keypad to the navigation pad separated from the keypad by the predetermined distance and manipulate the navigation pad while inputting characters by pressing keys of the keypad with his/her thumbs.

Because of the predetermined separation distance between the keypad and navigation pad, the character input time is lengthened due to the loss of time caused by movement from the keypad to the navigation pad.

In addition, because a character input operation using the keypad and navigation pad is typically performed only with the thumbs, the other fingers are underutilized for inputting characters or operating the mobile communication terminal.

### SUMMARY OF THE INVENTION

The present invention has been made in view of the above problems, and an object of the present invention is to provide a mobile communication terminal having multiple keypads and a main body of the mobile communication terminal which are easy to operate.

Another object of the present invention is to provide a mobile communication terminal having multiple keypads and a main body of the mobile communication terminal wherein not only the thumbs but also the other fingers are sufficiently utilized.

Another object of the present invention is to provide a mobile communication terminal having multiple keypads and a main body of the mobile communication terminal which can speed up a character input operation.

Another object of the present invention is to provide a mobile communication terminal having multiple keypads and a main body of the mobile communication terminal wherein a cursor can be moved rapidly in a leftward and rightward direction without manipulation of a navigation pad during a character input operation.

In order to achieve the objects, the present invention provides a main body of a mobile communication terminal, including a body part including a front side and a backside; a primary keypad installed on the front side of the body part; and secondary keypads installed on the backside of the body part.

Preferably, the secondary keypads are installed at the upper end portion of the backside of the body part. More preferably, the secondary keypads are installed at two opposite upper end edges of the backside of the body part, and may be button pads or touch pads.

In order to achieve the objects, the present invention further provides a mobile communication terminal including a main body including keypads installed on a front side and backside thereof; and a cover movably coupled to the front side of the main body so as to expose the keypads, the cover including a display screen.

The keypads may include a primary keypad installed at the front side of the main body, and secondary keypads installed at the backside of the main body and, the display screen is installed at a front side of the cover and a navigation pad is installed below the display screen.

In order to achieve the objects, the present invention further provides a mobile communication terminal including a body part including a front side and a backside; a display screen installed on an upper portion of the front side of the body part; a primary keypad installed below the display screen on the front side of the body part; and secondary keypads installed on the backside of the body part.

The mobile communication terminal may further include a navigation pad installed between the display screen and the primary keypad. Preferably, the secondary keypads are installed at two opposite upper end edges of the backside of the body part.

### BRIEF DESCRIPTION OF THE DRAWINGS

The above and other objects, features and advantages of the present invention will be more apparent from the following detailed description taken in conjunction with the accompanying drawings, in which:

FIG. 1 is a perspective view showing the backside of a mobile communication terminal having multiple keypads according to a first embodiment of the present invention;

FIG. 2 is a perspective view showing the front side of the mobile communication terminal of FIG. 1;

FIGS. 3A and 3B show usage states in the use of a primary keypad of the mobile communication terminal of FIG. 1;

FIGS. 4A and 4B show usage states in the use of secondary keypads of the mobile communication terminal of FIG. 1;

FIG. 5 is a perspective view showing the backside of a mobile communication terminal having multiple keypads according to a second embodiment of the present invention; and

FIG. 6 is a front view showing the front side of a mobile communication terminal having multiple keypads according to a third embodiment of the present invention.

### DETAILED DESCRIPTION OF PREFERRED EMBODIMENTS

Hereinafter, preferred embodiments of the present invention are described in detail with reference to the accompanying drawings.

### A. First Embodiment

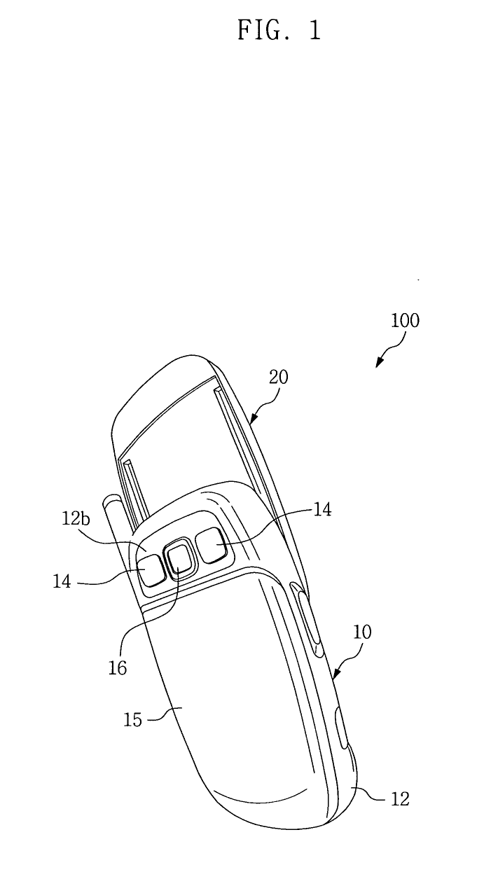

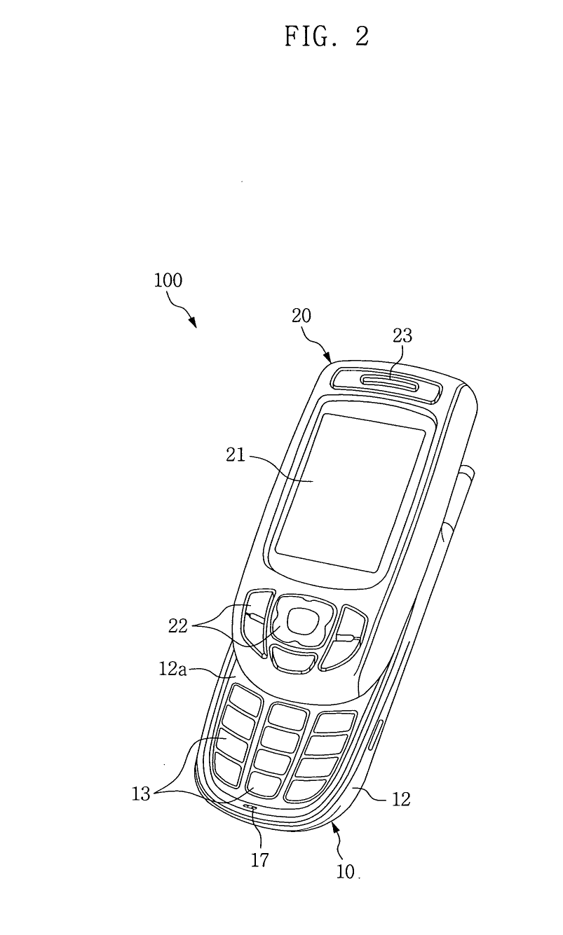

FIG. 1 is a perspective view showing a backside of a mobile communication terminal 100 having multiple keypads according to a first embodiment of the present invention. FIG. 2 is a perspective view showing a front side of the mobile communication terminal 100 of FIG. 1.

Referring to FIGS. 1 and 2, the mobile communication terminal 100 is a sliding type mobile communication terminal, and has a main body 10 and a cover 20 coupled to the main body 10. The keypads 13 and 14 are installed at the front side 12a and backside 12b, respectively, of the main body 10. The cover 20 is installed for up-down sliding on the main body 10, thereby covering and uncovering the keypad 13 at the front side 12a of the main body 10.

Because the keypads 13 and 14 are installed at two sides (front side 12a and backside 12b, respectively) of the main body 10, the user can manipulate the keypads 13 and 14 not only with his/her thumbs but also with his/her fingers. As a result, the user can rapidly and conveniently operate the mobile communication terminal 100.

The main body 10 includes a body part 12 on which the keypads 13 and 14 are installed, and a battery pack 15 is detachably coupled to the backside 12b of the body part 12. The battery pack 15 is installed below the upper end of the body part 12.

The keypads 13 and 14 include a primary keypad denoted by reference numeral 13 installed at the front side 12a of the body part 12 and secondary keypads denoted by reference numeral 14 installed at the backside 12b of the body part 12. The primary keypad 13 may be installed in the same arrangement as with a conventional keypad. The secondary keypads 14 are installed near to the upper end of the backside 12b of the body part 12.

In particular, it is preferable to install the secondary keypads 14 near to the two opposite upper end edges of the backside 12b of the body part 12, which are locations permitting the user to easily manipulate the secondary keypads 14 with index his/her fingers. That is, when the user holds the main body 10 in both hands, the index fingers are placed at the two opposite upper end edges of the backside 12b of the body part 12. While the secondary keypads 14 are manipulated, those fingers other than the index fingers support the main body 10. In the state when both thumbs are placed at the front side 12a of the body part 12, and remaining fingers are placed at the backside 12b of the body part 12 to support the main body 10, the secondary keypads 14 are manipulated with the index fingers.

Button pads may be used as the primary keypad 13 and the secondary keypads 14. Touch pads may also be used as the secondary keypads 14.

The secondary keypads 14 may be used as cursor movement keys, volume keys or camera keys during character input operations. That is, in a character input operation through the primary keypad 13, the cursor can be moved in the leftward and rightward direction by the secondary keypads 14 instead of by the navigation pad 22. Conventionally, a volume key is placed at a particular side of a mobile communication terminal. If the secondary keypads 14 are used as volume keys, they can be conveniently used by both a right-handed user and a left-handed user. If the mobile communication terminal 100 has a fixed camera module 16, the secondary keypads 14 can be used effectively as camera keys in a self-photographing operation. The secondary keypads 14 may also be utilized for various additional uses.

The cover 20 includes a display screen 21 installed at an upper front portion thereof, and the navigation pad 22 installed below the display screen 21.

A microphone 17 is installed below the primary keypad 13 of the main body 10 to receive an acoustic signal for voice communication. An earpiece 23 is installed above the display screen 21 of the cover 20 to output an acoustic signal. The camera module 16 capable of photographing a target object may be installed at the main body 10 or the cover 20, and in the present embodiment is installed at the main body 10.

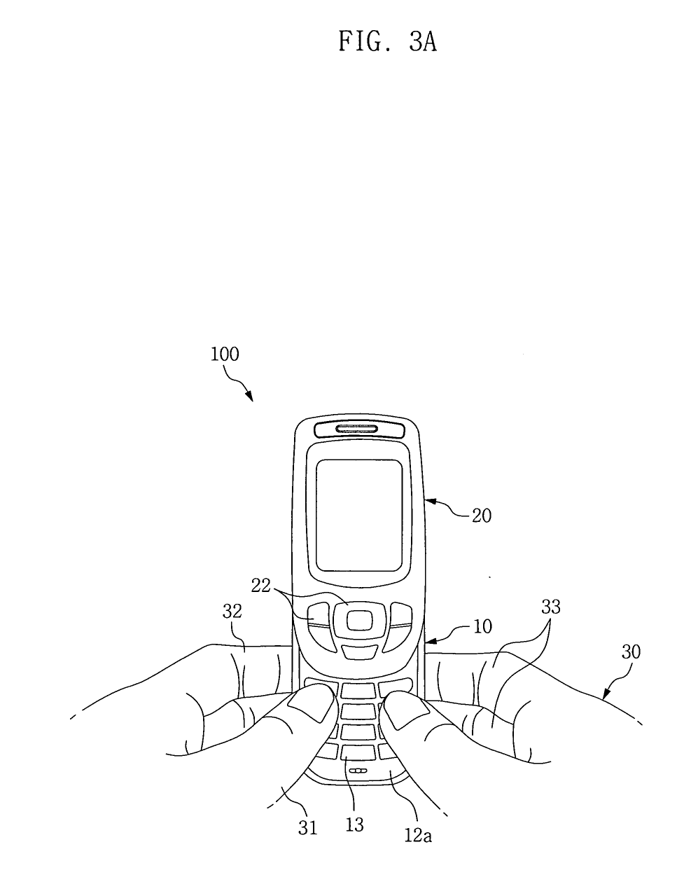

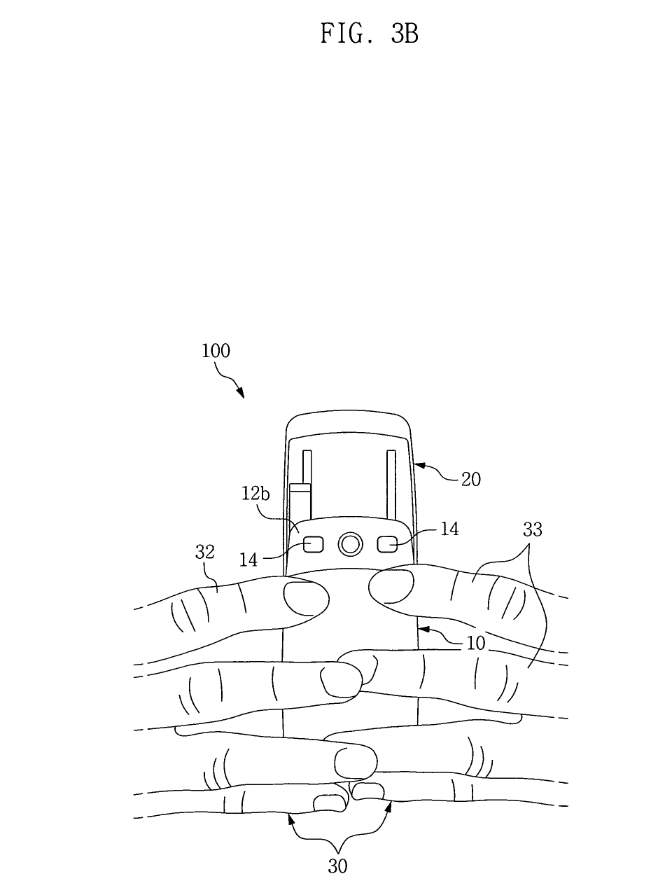

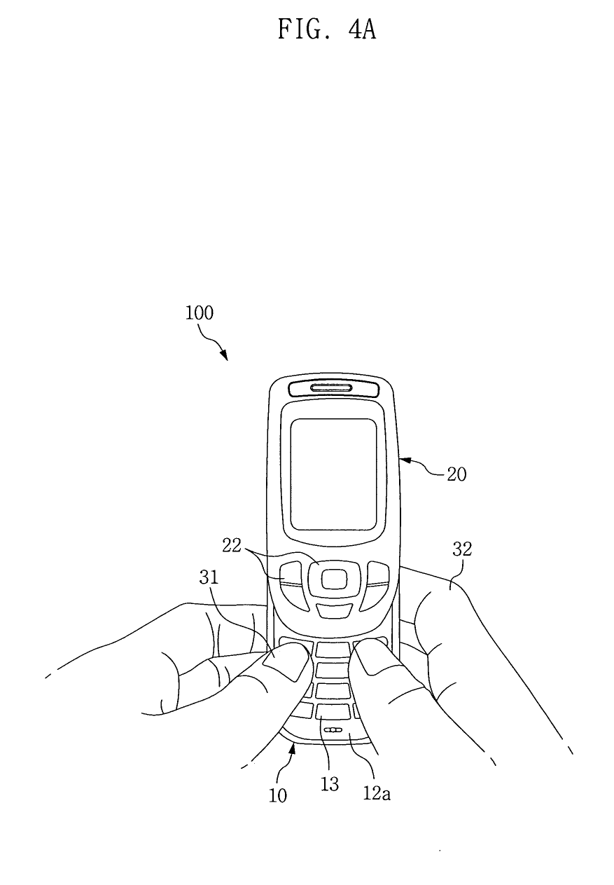

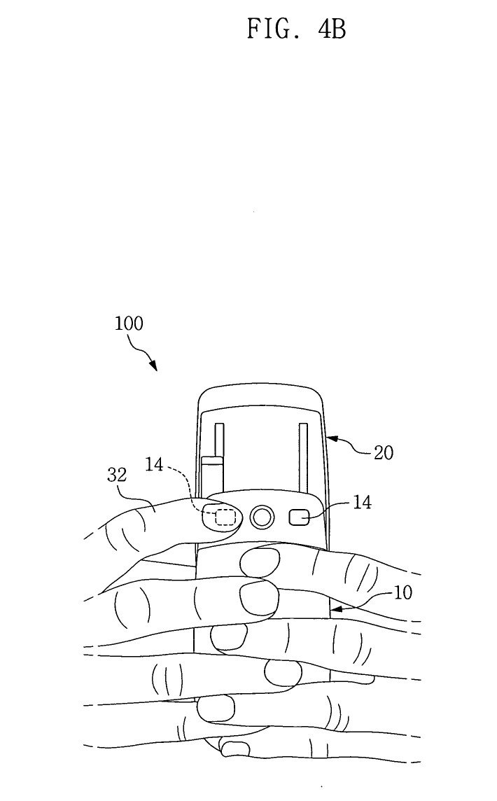

Examples of the keypads 13 and 14 in use according to the first embodiment are illustrated in FIGS. 3A to 4B. FIGS. 3A and 3B show usage states in the use of the primary keypad 13 of the mobile communication terminal 100 of FIG. 1, and FIGS. 4A and 4B show usage states in the use of the secondary keypads 14.

As shown in FIGS. 3A and 3B, the cover 20 is moved up relative to the main body 10 to expose the primary keypad 13. In the state when the backside 12b of the main body 10 is supported by fingers 33 of both hands 30 other than thumbs 31, the primary keypad 13 is manipulated with the thumbs 31. At this time, index fingers 32 may be placed at the secondary keypads 14 or near to the secondary keypads 14.

When the use of the secondary keypads 14 is needed during use of the primary keypad 13, as shown in FIGS. 4A and 4B, the secondary keypads 14 are manipulated with the index fingers 32 placed at the backside 12b of the main body 10. That is, the primary keypad 13 and the secondary keypads 14 can be simultaneously manipulated with the thumbs 31 and the index fingers 32, respectively.

For example, the primary keypad 13 and the secondary keypads 14 may be used as character input keys and cursor movement keys, respectively, in a character input operation. Thus, the user can input characters by pressing the primary keypad 13 with the thumbs 31, and move the cursor in the leftward and rightward direction by pressing the secondary keypads 14 with the index fingers 32. Consequently, the user can input characters rapidly and conveniently without use of the navigation pad 22. Compared with a conventional character input method in which the thumbs 31 are used to manipulate both the primary keypad 13 for inputting characters and the navigation pad 22 for moving the cursor in the leftward and rightward direction, the user can input characters more rapidly using the character input method of the present invention where the thumbs 31 are used to manipulate the primary keypad 13 for inputting characters and the index fingers 32 are used to manipulate the secondary keypads 14 for moving the cursor leftward and rightward.

### B. Second and Third Embodiments

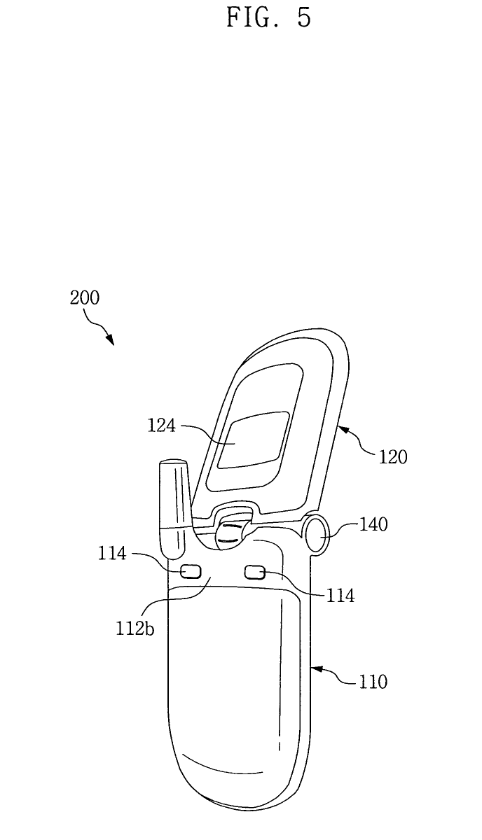

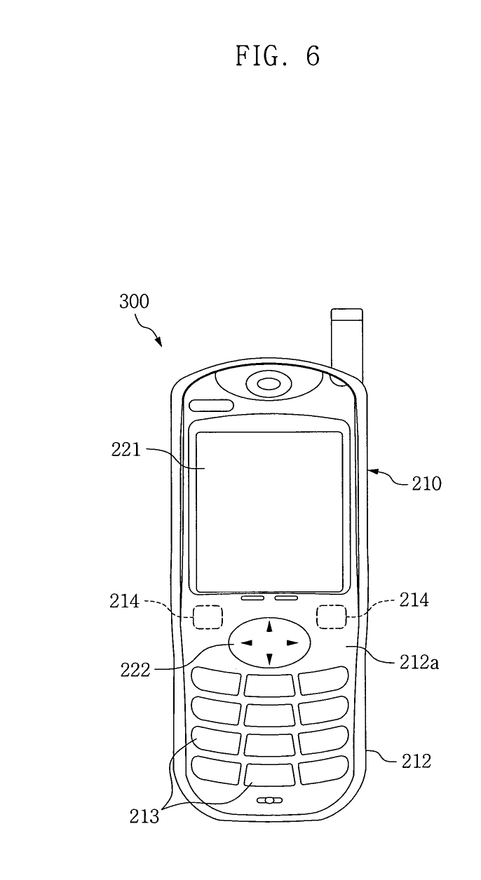

Although, in the first embodiment, multiple keypads of the present invention are applied to a sliding type mobile communication terminal, they are also applicable to other types of mobile communication terminals including a bar type, cover-equipped flip type and folder type. For example, FIG. 5 shows a folder type mobile communication terminal 200 having multiple keypads and FIG. 6 shows a bar type mobile communication terminal 300 having multiple keypads.

As shown in FIG. 5, the mobile communication terminal 200 according to the second embodiment is a folder type. Secondary keypads 114 are installed at the backside 112b of a main body 110. In the mobile communication terminal 200, adjacent ends of the main body 110 and of a folder or cover 120 are coupled with each other through a hinge 140. In particular, the secondary keypads 114 are installed near to the two opposite upper end edges of the backside 112b of the main body 110.

Although not shown, a primary keypad is installed at the front side of the main body 110 and a navigation pad is installed above the primary keypad. A main display screen (not shown) is installed on a side of the folder 120 facing the front side of the main body 110.

The folder 120 may include a secondary display screen 124 installed at a side thereof opposite to the side where the main display screen is installed, and may be configured to be rotatable in a 90-degree angle so that the display screen is viewable in another direction.

As shown in FIG. 6, the mobile communication terminal 300 according to the third embodiment is a bar type. Secondary keypads 214 are installed at the backside of a main body 210. The mobile communication terminal 300 has a body part 212 including a front side 212a and the backside (not shown). A display screen 221 is installed at an upper portion of the front side 212a of the body part 212. A primary keypad 213 is installed below the display screen 221 on the front side 212a of the body part 212. The secondary keypads 214 are installed on the backside of the body part 212. A navigation pad 222 is installed between the display screen 221 and the primary keypad 213.

As apparent from the above description, the present invention aims to provide a mobile communication terminal having multiple keypads installed at two sides that is easy to operate. In particular, secondary keypads are installed at two opposite upper end edges of the backside of a main body, where the index fingers are placed when the user holds the main body with both hands, thereby enabling the user to manipulate the secondary keypads with ease.

Because a primary keypad is installed on the front side of the main body and the secondary keypads are installed at two opposite upper end edges of the backside of the main body, the primary keypad can be manipulated with the thumbs and the secondary keypads can be manipulated with the index fingers. Consequently, the user can operate the mobile communication terminal more easily with both the thumbs and index fingers.

In a character input operation, the user can rapidly move the cursor in the leftward and rightward direction using the secondary keypads installed on the backside of the main body as cursor movement keys without the use of a navigation pad. The user can input characters by pressing the primary keypad installed on the front side of the main body with the thumbs, and move the cursor leftward and rightward by pressing the secondary keypads with the index fingers. Thus, the character input speed can be increased.

In addition, the secondary keypads can be used as various function keys such as volume keys and camera keys.

The present invention is disclosed in the preferred embodiments shown in this specification and in the accompanying drawings. This disclosure is not intended to limit the scope of the invention, but to serve only for illustrative purposes. It should be understood to the ordinary person skilled in the art that various changes or modifications of the embodiments are possible without departing from the spirit of the invention.

What is claimed is:

1. A main body of a mobile communication terminal, comprising:
a body part having a front side and a backside;
a primary keypad installed on the front side of the body part; and
secondary keypads installed on the backside of the body part.

2. The main body of claim 1, further comprising a battery pack coupled below an upper end portion of the backside of the body part.

3. The main body of claim 1, wherein the secondary keypads are installed at the upper end portion of the backside of the body part.

4. The main body of claim 3, wherein the secondary keypads are installed at two opposite upper end edges of the backside of the body part.

5. The main body of claim 1, wherein the secondary keypads are one of button pads and touch pads.

6. A mobile communication terminal comprising:
a main body including keypads installed at a front side and a backside thereof; and
a cover movably coupled to the front side of the main body so as to expose at least one of the keypads, the cover including a display screen.

7. The mobile communication terminal of claim 6, wherein the keypads comprise:
a primary keypad installed on the front side of the main body; and
secondary keypads installed on the backside of the main body.

8. The mobile communication terminal of claim 7, wherein the main body comprises:
a body part including the keypads; and
a battery pack coupled below an upper end portion of the backside of the body part,
wherein the secondary keypads are installed at the upper end portion of the backside of the body part.

9. The mobile communication terminal of claim 8, wherein the secondary keypads are installed at two opposite upper end edges of the backside of the body part.

10. The mobile communication terminal of claim 7, wherein the secondary keypads are one of button pads and touch pads.

11. The mobile communication terminal of claim 6, wherein the display screen is installed on a front side of the cover and a navigation pad is installed below the display screen.

12. The mobile communication terminal of claim 7, wherein the main body further includes a navigation pad installed above the primary keypad.

13. A mobile communication terminal comprising:
a body part including a front side and a backside;
a display screen installed at an upper portion of the front side of the body part;
a primary keypad installed below the display screen on the front side of the body part; and
secondary keypads installed on the backside of the body part.

14. The mobile communication terminal of claim 13, further comprising a navigation pad installed between the display screen and the primary keypad.

15. The mobile communication terminal of claim 14, wherein the secondary keypads are installed at two opposite upper end edges of the backside of the body part.

16. The mobile communication terminal of claim 13, wherein the secondary keypads are one of button pads and touch pads.
